(19) United States
(12) Patent Application Publication
(10) Pub. No.: US 2010/0242087 A1
(43) Pub. Date: Sep. 23, 2010

(54) DISPLAY DATA TRANSMISSION DEVICE AND METHOD THEREOF

(75) Inventor: Shinichi Matsumoto, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Tokyo (JP)

(21) Appl. No.: 11/463,514

(22) Filed: Aug. 9, 2006

(30) Foreign Application Priority Data
Aug. 11, 2005 (JP) 2005-233593

(51) Int. Cl. G06F 21/00; G06F 3/14

(52) U.S. Cl. 726/3; 715/741

(57) ABSTRACT

A display data transmission device includes a security level data acquisition unit configured to acquire security level data about a security level of a display device connected through a network, and a display data transmission unit configured to transmit display data created in a format corresponding to the security level data acquired by the security level data acquisition unit.

### BACKGROUND OF THE INVENTION

1. Field of the Invention

The present invention relates to a display data transmission device, a display data transmission method, and a display system. Particularly, the present invention relates to a technique suitable for use in display of display data maintaining a high level of security.

2. Description of the Related Art

Currently, various kinds of instruments are generally connected on a network to exchange data (or information) or share data mutually. These circumstances allow the data to be easily transferred to other instruments through the network. Accordingly, cases where an ill-intentioned user brings out important files and data outside have also increased.

In the conventional technique, in order to prevent leakage of such highly confidential data, strict authentication of an instrument or a person is employed. This technique restricts a person who can access data. Namely, the data itself is encrypted, and if a decryption key is not used, the data can not be viewed.

On the other hand, in a case of making a presentation using a display device such as a projector, a participating member can only view a page or the part that is being described. Hence, such a presentation is not appropriate to view a list of data. Further, if a hard copy is distributed on the occasion, print or copy work for the number of participants has consumed much time. Reproducibility in color and resolution compared with an original can be limited due to print quality.

### SUMMARY OF THE INVENTION

The present invention is directed to a display data transmission device providing display data having high convenience while retaining security.

According to an aspect of the present invention, a display data transmission device includes a security level data acquisition unit configured to acquire security level data about a security level of a display device connected through a network, and a display data transmission unit configured to transmit display data created in a format corresponding to the security level data acquired by the security level data acquisition unit, to the display device.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 is a diagram of a display system according to a first exemplary embodiment.

FIG. 2 is a block diagram showing a schematic configuration of a display data transmission device according to a first exemplary embodiment.

FIG. 3 is a block diagram showing a schematic configuration of a display device according to a first exemplary embodiment.

FIG. 4 is a flowchart representing the details of data transmission processing of a display data transmission device according to a first exemplary embodiment.

FIG. 5 is a flowchart representing the details of display processing of a display device according to a first exemplary embodiment.

FIG. 6 is a table for authentication according to a first exemplary embodiment.

FIG. 7 is a diagram representing the data structure of Bit Map data according to a first exemplary embodiment.

FIG. 8 is a diagram representing a list describing vector data according to a first exemplary embodiment.

FIG. 9 is a diagram representing a processing sequence in a display data transmission device and a display device according to a second exemplary embodiment.

FIG. 10 is a table to be referred to for authentication and acquisition of an authenticated security level of a user according to a second exemplary embodiment.

FIG. 11 is a network arrangement diagram in which a display data transmission device and a display device are installed according to a third exemplary embodiment.

FIG. 12 is a diagram representing the structure of a storage according to a fourth exemplary embodiment.

FIG. 13 is a diagram representing a processing sequence in a display data transmission device and a display device according to a fifth exemplary embodiment.

FIG. 14 is a flowchart representing the details of data transmission processing of a display data transmission device according to a fifth exemplary embodiment.

FIG. 15 is a flowchart representing the details of display processing of a display device according to a fifth exemplary embodiment.

FIG. 16 is a diagram showing a description example of the attribute information about a VRAM according to a fifth exemplary embodiment.

FIG. 17 is a diagram showing a description example of the attribute information about display according to a fifth exemplary embodiment.

### DETAILED DESCRIPTION OF THE EXEMPLARY EMBODIMENTS

Exemplary embodiments of the present invention will be described in detail below with reference to the drawings.

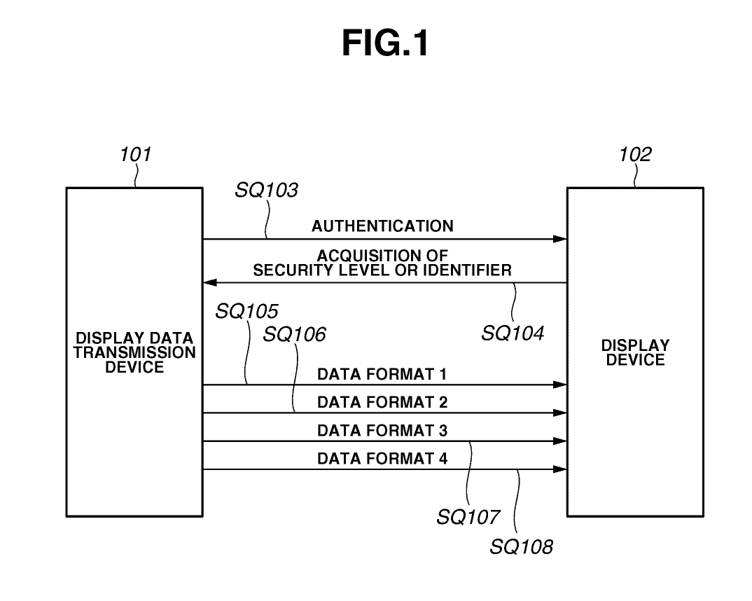

FIG. 1 is a diagram of a display system according to a first exemplary embodiment. In FIG. 1, the display system is configured of a display data transmission device 101 and a display device 102. Each device is connected by a network. According to the present exemplary embodiment, first, in a sequence SQ103, the display data transmission device 101 requests authentication from the display device 102. In a sequence SQ104, the display data transmission device 101 identifies the display device 102 itself. As a result of authentication, the display data transmission device 101 acquires the value of a security level or a device identifier (ID of display device 102) related to the display device 102 in order to acquire a reliability factor of the display device 102. The display data transmission device 101 determines the security level from the acquired value (value of security level or device identifier). Then, the display data transmission device 101 transmits display data in a format corresponding to the security level (sequences SQ105, SQ106, Sq107 and SQ108).

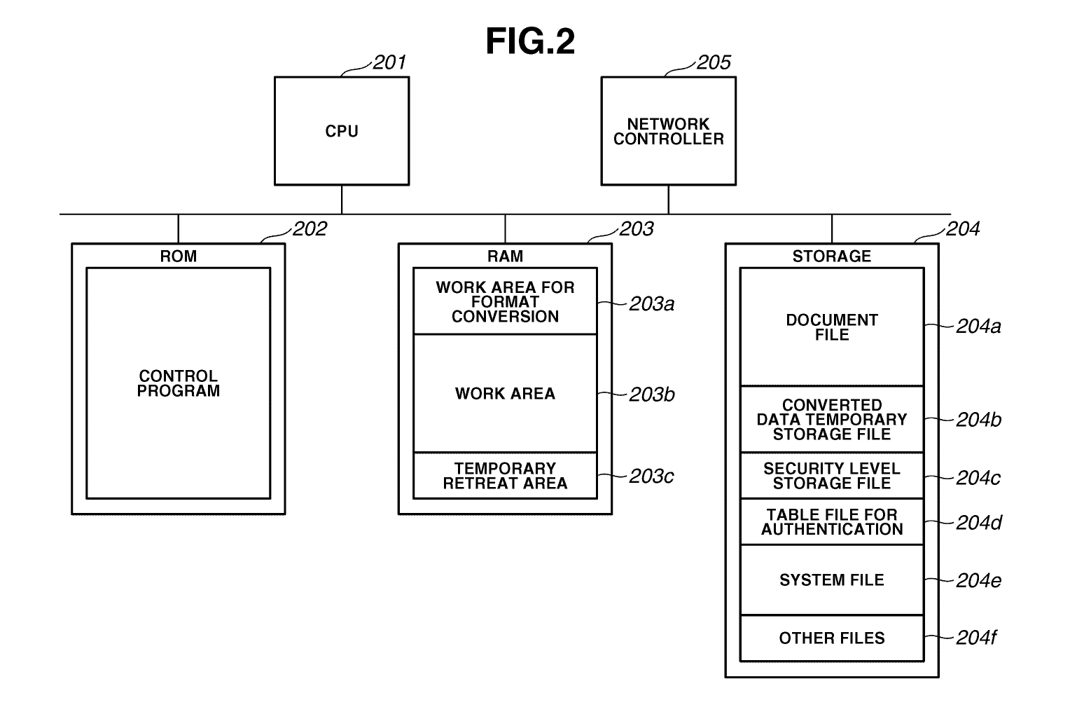

FIG. 2 is a block diagram showing a schematic configuration of the display data transmission device 101 according to the first exemplary embodiment. In FIG. 2, a CPU (central processing unit) 201 executes a control program stored in a ROM (read only memory) 202 to control the operation of the whole display data transmission device 101.

The CPU 201 is connected with the ROM 202, a RAM 203 (random access memory), a storage 204, and a network controller 205 through a data bus.

The ROM 202 stores a program and data based on which the CPU 201 controls the display data transmission device 101. The RAM 203 is a memory for writing and reading data when the CPU 201 executes the program of the ROM 202. Areas of the RAM 203 include a work area for format converting 203a, a work area 203b, and a temporary retreat area 203c as shown in FIG. 2.

The work area for format converting 203a is used when the CPU 201 executes conversion of an original file, which is already stored in the storage 204, into a data format for display. The work area 203b is used by the CPU 201 in other processing.

According to the present exemplary embodiment, the storage 204 is a non-volatile memory such as a hard disk. In the storage 204, a file system is constructed. The storage 204 can store various kinds of data as a file.

In the storage 204, a file 204a serving as a document file is stored. The document file described in this exemplary embodiment designates the original file generated by a document creating application such as word-processing, spreadsheet or presentation application. A file 204b serves as a temporary storage file of converted data. The file 204b is temporarily stored as a data format file for display that is converted from the original file stored in the file 204a. A file 204c stores the security level (value of security level). The file 204c includes information about the security level acquired from the display device 102. A file 204d serves as a table for authentication. The file 204d includes information concerning a table that describes correspondence between the information acquired from the display device 102, and the security level or the converted data format. A file 204e serves as a system file used by an operating system. A file 204f includes other files. For example, the file 204f includes information (e.g. an initial value and a table) necessary for the CPU 201 to control the operation of the display data transmission device 101.

The net work controller 205 controls the transmission and reception of data through the network.

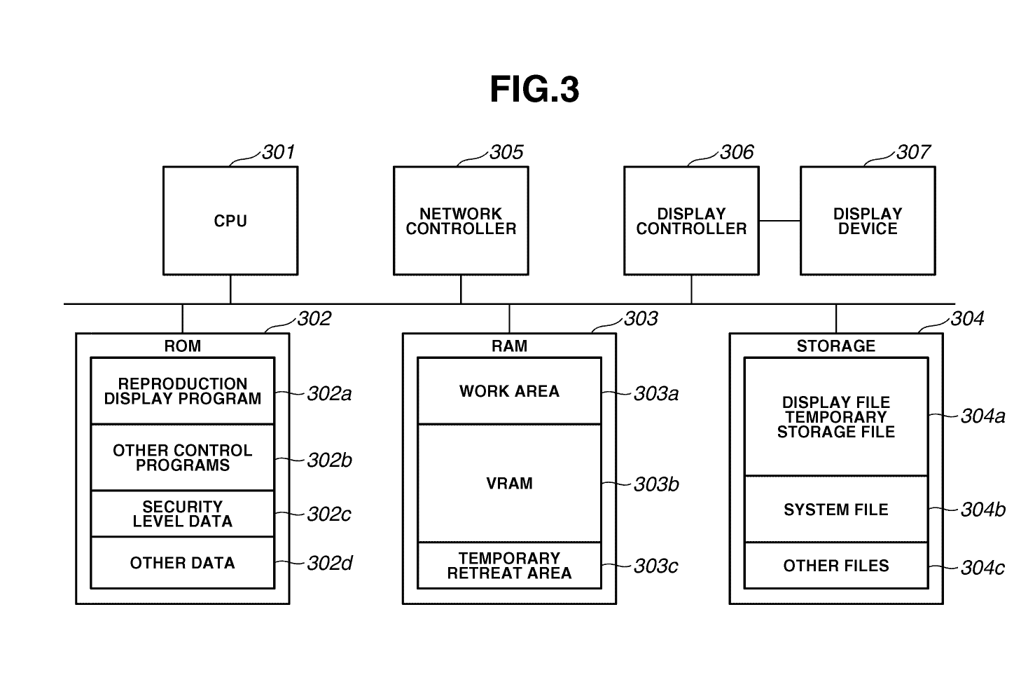

FIG. 3 is a block diagram showing a schematic configuration of the display device 102 according to the first exemplary embodiment. In FIG. 3, a CPU 301 executes a control program stored in a ROM 302 to control the operation of the whole device. The CPU 301 is connected with the ROM 302, a RAM 303, a storage 304, a network controller 305, and a display controller 306 through a system bus. The display controller 306 is connected with a display device 307.

The ROM 302 stores a program and data based on which the CPU 301 controls the display device 102. For example, as shown in FIG. 3, the ROM 302 stores a reproduction display program 302a, other control programs 302b, security level data 302c, and other data 302d.

In this exemplary embodiment, the reproduction display program 302a is a control program for reading and displaying display data transmitted from the display data transmission device 101. Other control programs 302b execute other controls. The security level data 302c is the value of a security level or the device identifier. Other data 302d are various fixed data, for example, those required in the control of the display device 102.

The RAM 303 is a memory for writing and reading data when the CPU 301 executes the program of the ROM 302. An area contained in the RAM 303 includes a work area 303a, a VRAM (video RAM) 303b, and a temporary retreat area 303c as shown in FIG. 3.

The work area 303a is used when the CPU 301 executes processing. The VRAM 303b is an area in which a display image is rasterized. The display controller 306 reads data in the VRAM 303b and outputs the data to the display device 307. The display data in the VRAM 303b is configured as a raster image in which each RGM is 8 bits.

In this exemplary embodiment, the storage 304 is a non-volatile memory such as a flash ROM. In the storage 304, a file system is constructed. Various kinds of data can be stored in the storage 304 as a file. In the storage 304, a file 304a temporarily stores display data transmitted from the display data transmission device 101. When a reproduction and display program 302a is executed, the CPU 301 reads the file 304a (display data file), rasterizes it into the raster image, and writes it into the VRAM 303b. A system file 304b is used by the operating system. Further, a file 304c includes, for example, information (e.g., an initial value and a table) necessary for the CPU 301 to control the operation of the device.

The network controller 305 controls the transmission and reception of data through the network. As described above, the display controller 306 reads the display data (i.e., the raster image) stored in the VRAM 303b at a cycle of 60 Hz and outputs it to the display device 307. In the present exemplary embodiment, the display device 307 is a color liquid crystal display having resolution of an XGA size (1024×768 pixels).

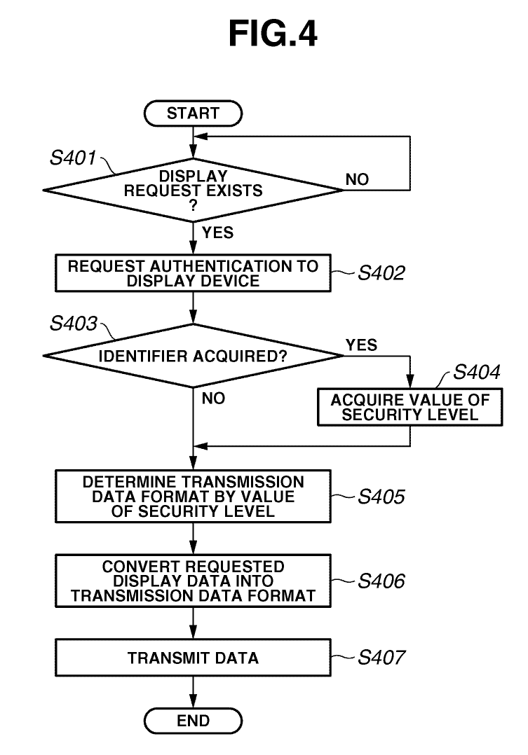

The processing of the display data transmission device 101 and the display device 102 according to the present exemplary embodiment will be described in detail below. FIG. 4 is a flowchart showing the details of data transmission processing of the CPU 201 in the display data transmission device 101.

First, in step S401, the CPU 201 waits until it receives a display request from the display device 102. When the display request is received, in step S402, the CPU 201 requests authentication from the display device 102 that issued the request. In negotiation with the display device 102, the CPU 201 requests transmission of the value of a security level embedded (or stored) in the display device 102, or an intrinsic and unique device identifier (for example, MAC address).

In step S403, the CPU 201 determines whether the received value (or ID) is the device identifier. If the received value is the device identifier, in step S404, the CPU 201 acquires the value of a security level stored in the file 204d referring to a corresponding table between the device identifier and the value of a security level. This corresponding table can also automatically be written by the display data transmission device 101 depending on a state of the display device 102 which is present on the network. Thereafter, the operation proceeds to step S405. On the other hand, if the value of a security level is directly received in the step S403, the operation simply proceeds to the step S405.

In the step S405, based on the value of a security level, the CPU 201 determines a display data format that is transmitted to the display device 102 referring to the corresponding table between the value of a security level and a data format stored in the area of the file 204d. Next, in step S406, the CPU 201 converts the data requested from the display device 102 into a data format corresponding to the value of a security level and creates the file of a transmission data format. Then, in step S407, the CPU 201 transmits the file created in the step S406 to the display device 102 through the network controller 205.

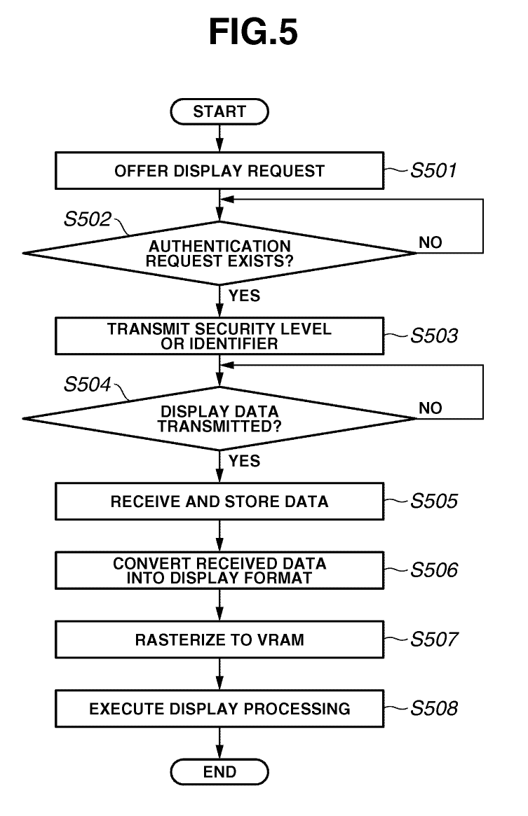

FIG. 5 is a flowchart showing the details of display processing of the CPU 301 to be executed in the display device 102. In step S501, the CPU 301 requests that data to be displayed are transmitted to the display data transmission device 101. Next, in step S502, the CPU 301 waits until an authentication is requested from the display data transmission device 101. When the authentication is requested, in step S503, the CPU 301 transmits the value of a security level embedded in the display device 102, or an intrinsic and unique device identifier (for example, MAC address). Thereafter, in step S504, the CPU 301 waits until the display data are transmitted. When transmission starts, in step S505, the CPU 301 executes reception processing and stores the received data in the file 304a at the same time.

Next, in step S506, the CPU 301 reads the data file stored in the step S505 and converts it into the raster image. In step S507, the CPU 301 executes processing of rasterizing in the VRAM 303. Then, in step S508, the CPU 301 executes processing of outputting the VRAM image to the display device 307 with the display controller 306. Thus, the data is displayed on the display device 307.

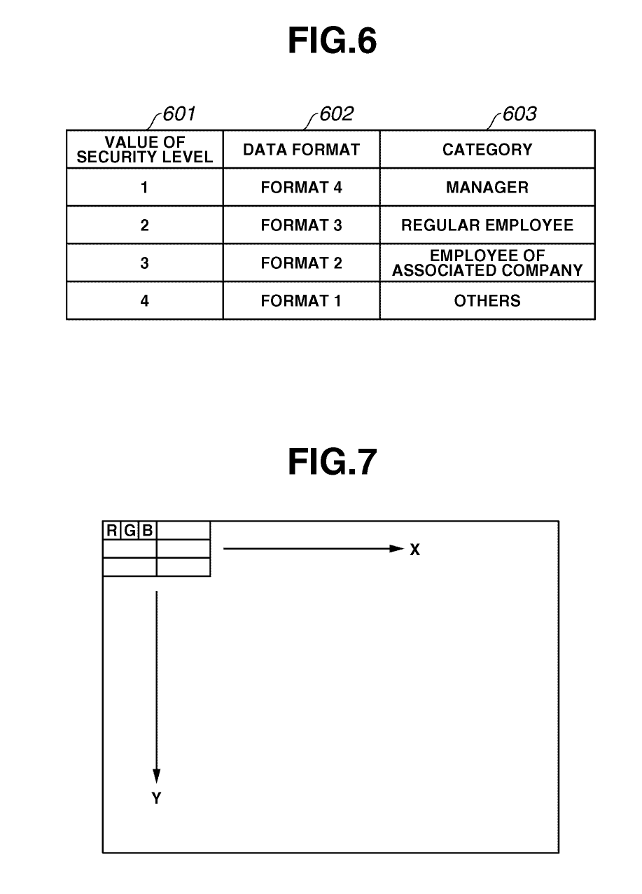

FIG. 6 is a diagram showing the table structure described in the table file 204d for authentication stored in the storage 204 in FIG. 2. The table shown in FIG. 6 is referred to when the display data transmission device 101 determines a data format that is transmitted based on the acquired value of a security level in the step S405 in FIG. 4.

In FIG. 6, an item 601 is the value of a security level. In the present exemplary embodiment, the item 601 is classified into security levels 1 to 4. An item 602 is a data format in which data formats 1 to 4 are set and the data format corresponding to each security level is described. An item 603 describes which category is targeted by each security level.

In the present exemplary embodiment, a data format 1 is a Bit Map (BMP) data format having the same size as the display area of the display device 102, the BMP data format of the raster image corresponding to one screen in which Bit Map data is compressed and encoded, a JPEG (Joint Photographic Experts Group) data format, or a GIF (Graphic Interchange Format) data format. That is, the data format 1 displays the data simply in a stationary manner in the display device 102. Accordingly, even if the data in the data format 1 is magnified in the display device 102, display quality can not be improved. The data structure of the Bit Map data is shown in FIG. 7. Since the data structure itself is generally known in the art, the description will be omitted.

Further, a data format 2 is a Bit Map data format having a smaller size than the display area of the display device 102 or a data format in which the Bit Map data is compressed and encoded. Further, the data format 2 is PDF data in which the display data are configured only by the raster image, the JPEG data or the GIF data, or other data formats in which page description is possible. The page changing operation or the scrolling operation of the data in this data format 2 can be performed by a user to a display screen.

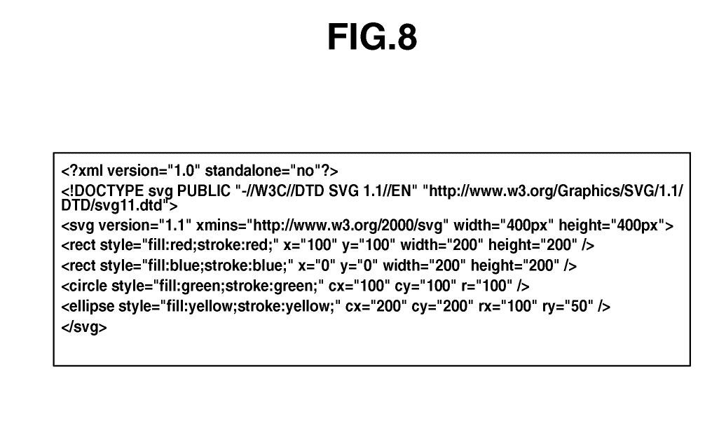

In a data format 3, the display screen is configured with vector data which is assumed to have a PDF data format or a SVG data format described by vector information. A user can change a display form, for example, can resize or deform display data in this data format 3 without loss of display quality through the display device 102. A part of lists described in the vector data is shown in FIG. 8.

A data format 4 is the original file created from an application. The data format 4 is a document data format created by the application such as word processing, spreadsheet or presentation. A user can change data, for example, can perform editing or addition to the data in this data format 4 in the display device 102.

In the first exemplary embodiment, the security level is acquired by directly reading the security level embedded in the display device 102 or executing authentication from the identifier intrinsically allocated to the display device 102, when the display data transmission device 101 acquires the security level of the display device 102.

In a second exemplary embodiment, a security level is acquired by authenticating a user who uses the display device 102.

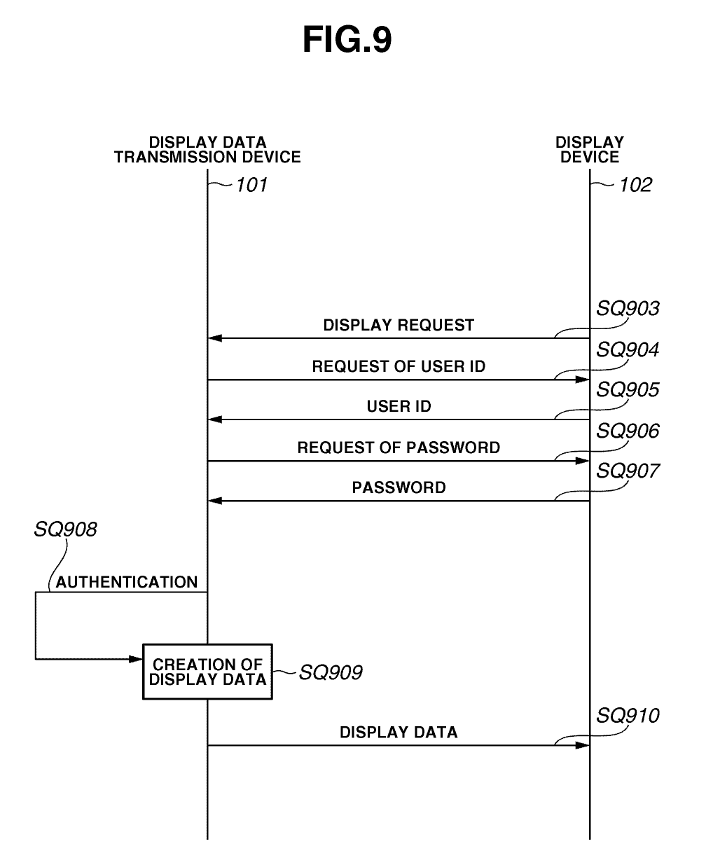

FIG. 9 is a diagram representing a processing sequence in the display data transmission device 101 and the display device 102 according to the second exemplary embodiment.

First, in a sequence SQ903, the display request of data is transmitted from the display device 102. The display data transmission device 101 receives the request and in a sequence SQ904, requests the user ID of a user who uses the display device 102. In response to this request, the display device 102 executes display requesting the user to input the user ID. The user inputs the user ID with a keyboard, a touch panel or other methods attached to the display device 102. Then, in a sequence SG 905, the display device 102 transmits the user ID to the display data transmission device 101. The user ID can directly be inputted, or a user name can be inputted and converted into the user ID by the processing inside the display device 102. The display data transmission device 101 that receives the user ID determines whether the user ID is registered. When it is determined that the user ID is registered, next, in a sequence SQ906, the display data transmission device 101 requests the password of the registered ID (registered user ID) from the display device 102.

In a sequence SQ907, the display device 102 executes display requesting the user to input the password similarly as in the case where the user ID is inputted. When the user inputs the password, in the sequence SQ907, the password is transmitted to the display data transmission device 101. The display device 102 can transmit the password in a plain-text or in an encrypted form. Alternatively, in the sequence SQ904, the display data transmission device 101 requests to transmit a combination of the user ID and the password. The display device 102 receives this request, and requests the user to input the user ID and the password. When the inputting is completed, the display device 102 transmits the user ID and the password to the display data transmission device 101 as a set of data.

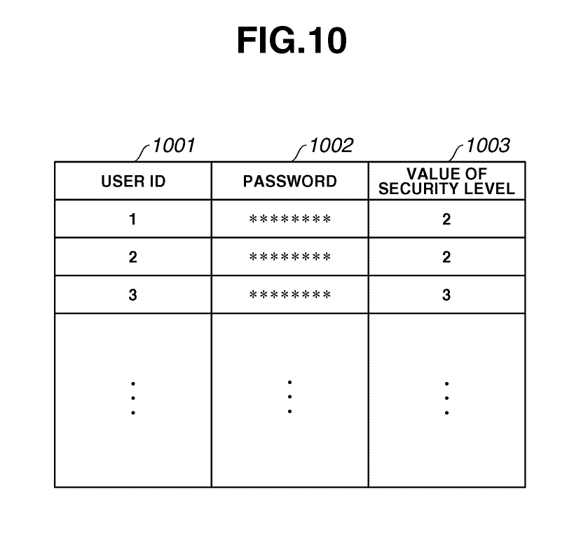

In a sequence SQ908, the display data transmission device 101 receives the user ID and the password and checks whether the received set of user ID and password coincides with any one of the user ID and password sets that are held in a table. If the set of the received user ID and password coincides with one of them, the display data transmission device 101 refers to the value of a security level allocated to this user ID. In a sequence SQ909, the display data transmission device 101 creates the display data corresponding to the referred value of a security level. The processing of creating the display data in the display data transmission device 101 is similar to the processing described in the step S406 in FIG. 4. The value of a security level in the display data transmission device 101 is acquired referring to the table in FIG. 10. When the creation of the display data is completed, the display data transmission device 101 transmits the created data to the display device 102 in a sequence SQ910.

FIG. 10 illustrates the structure of a table that is referred to for authentication and for acquisition of the authenticated value of a security level of a user, in the authentication processing described in the sequence SQ908 of FIG. 9.

The table in FIG. 10 includes items of a user ID 1001, a password 1002 corresponding to each user ID, and the value of a security level 1003. The table in FIG. 10 is stored in the area of the file 204d in FIG. 2.

In the first and the second exemplary embodiments, the security level is allocated to the main body of the display device 102 or to the user who uses the display device 102. In a third exemplary embodiment described below, the security level is determined corresponding to a place at which the display device is installed.

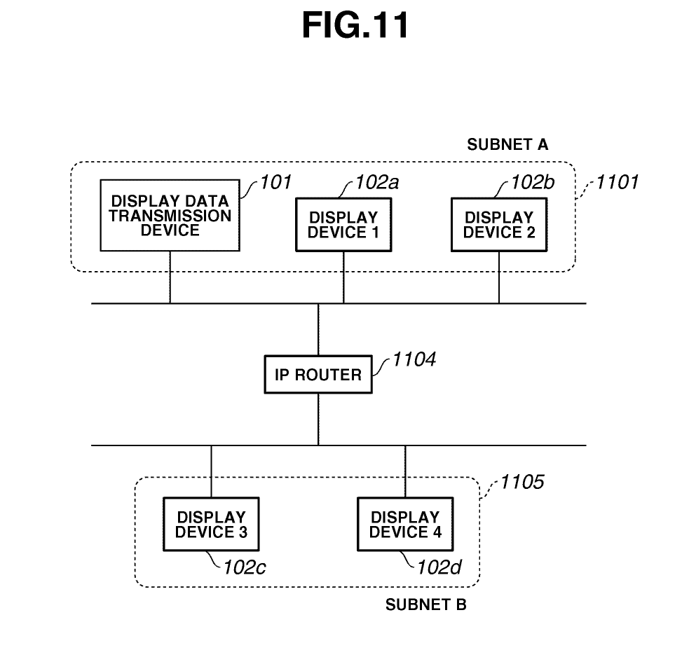

FIG. 11 is a network arrangement diagram in which the display data transmission device 101 and the display device 102 (102a to 102d) are installed. In FIG. 11, a subnet (A) 1101 is connected with a plurality of devices such as the display data transmission device 101, or a display device (1) 102a having the same network address and a different IP address. A subnet (B) 1105 has a network address different from the subnet (A). The subnet (B) 1105 is connected with a plurality of devices having the same network address and a different IP address such as a display device (3) 102c. An IP router 1104 connects the subnet (A) 1101 and the subnet (B) 1105 to execute routing.

In the third exemplary embodiment, the same security level is allocated to a device connected to the same subnet. That is, there are two cases. The security levels of the display device 102 connected to the subnet (A) 1101 can be the same as the security levels of the display device 102 connected to the subnet (B) 1105, or can be different from them. A table for correspondence between the subnet and the security level is described in the storage file of the security level 204c in the display data transmission device 101. The display data transmission device 101 can acquire the security level of the display devices 102a to 102d of each subnet referring to the storage file of the security level 204c.

Further, in order to determine the security level based on a place where the display devices 102a to 102d is installed, for example, a system can be employed, in which the display data transmission device 101 acquires position information such as a GPS (Global Positioning System). In this case, by using the GPS, the display data transmission device 101 acquires information representing a position and an area where the display device is employed. Thus, the display data transmission device 101 dynamically allocates a different security level according to the acquired information.

In the first exemplary embodiment, when the display request is issued from the display device 102, the display data is created in the display data transmission device 101 (refer to steps S401 to S406 in FIG. 4). In a fourth exemplary embodiment, the display data transmission device 101 creates and stores the display data corresponding to each security level beforehand in a plurality of formats.

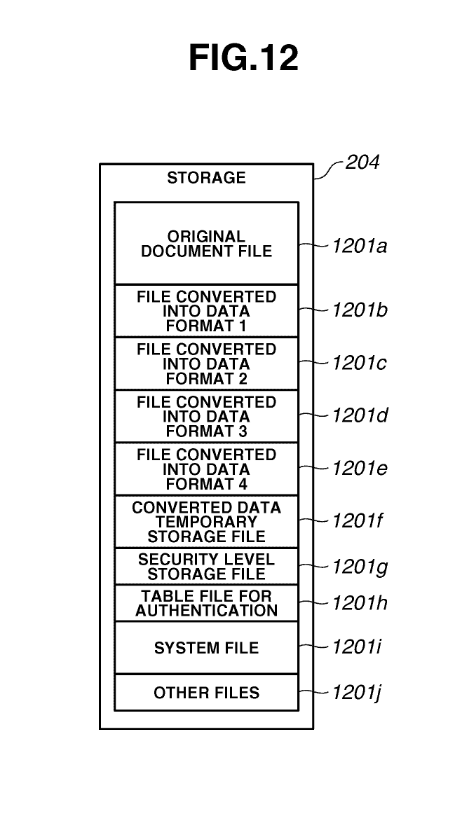

FIG. 12 is a diagram representing a structure according to the fourth exemplary embodiment of the storage 204 described in FIG. 2. In the storage 204 of FIG. 12, a file system is constructed on a hard disk similar to FIG. 2. In the storage 204, a file 1201a is an original document file and is generated by the document creating application similar to the file 204a. This original file can be the same data as data for each display described below. A file 1201b is a display data file converted into a display data format 1. Files 1201c, 1201d and 1201e are display data files converted into data formats 2, 3 and 4, respectively. These display data files are created by the processing of the CPU 201 in the display data transmission device 101 when the original file 1201a is created or received from other instruments through the network.

The following files 1201f to 1201j correspond to the files 204b to 204f in FIG. 2, respectively. That is, the file 1201f is a temporary storage file of converted data. The file 1201g stores a security level. The file 1201h is a table for authentication. The file 1201i is a system file. The file 1201j is other files.

When the display data transmission device 101 receives the display request from the display device 102, the display data transmission device 101 acquires the value of a security level in authentication processing. When the value of a security level is determined, the display data transmission device 101 searches the file of a display data format corresponding to the value of the security level from the file system of the storage 204 and transmits the searched file to the display device 102 as display data.

Further, in other processing method, the display data transmission device 101 creates display data only one time when the display data transmission device 101 receives the display request from the display device 102. The created display data is not erased and is saved in the storage area of each data format on the system file described in FIG. 12. In this case, the display data transmission device 101 converts data when a first request is received. Thereafter, when the request is issued as to the same data, the display data previously created can be transmitted.

In the first to fourth exemplary embodiments, the display data in the Bit Map format transmitted from the display data transmission device 101 to the display device 102 is once stored in the storage part 304 of the display device 102 as a file. The CPU 301 reads and writes the file into the VRAM 303b.

In a fifth exemplary embodiment, data transmitted from the display data transmission device 101 has a data format similar to the format that is written into the VRAM 303b. The display device 102 that received the data, directly writes the data into the VRAM 303b from the network controller 305.

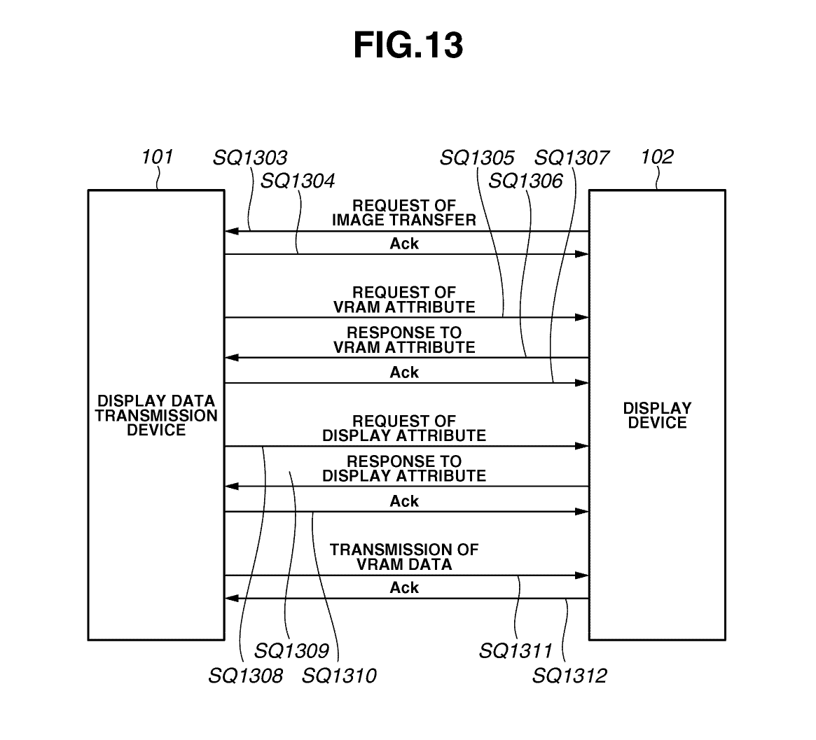

FIG. 13 is a diagram illustrating a processing sequence in the display data transmission device 101 and the display device 102 according to the fifth exemplary embodiment.

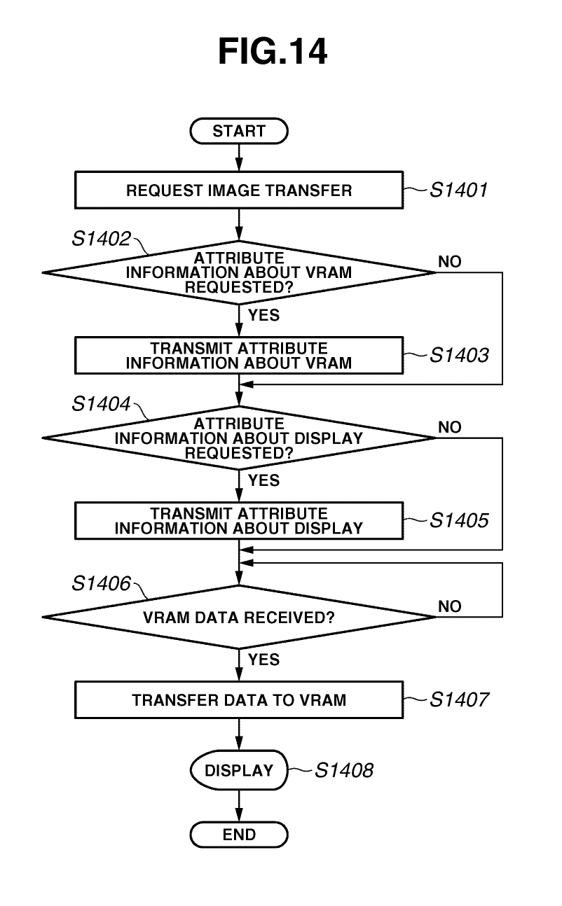

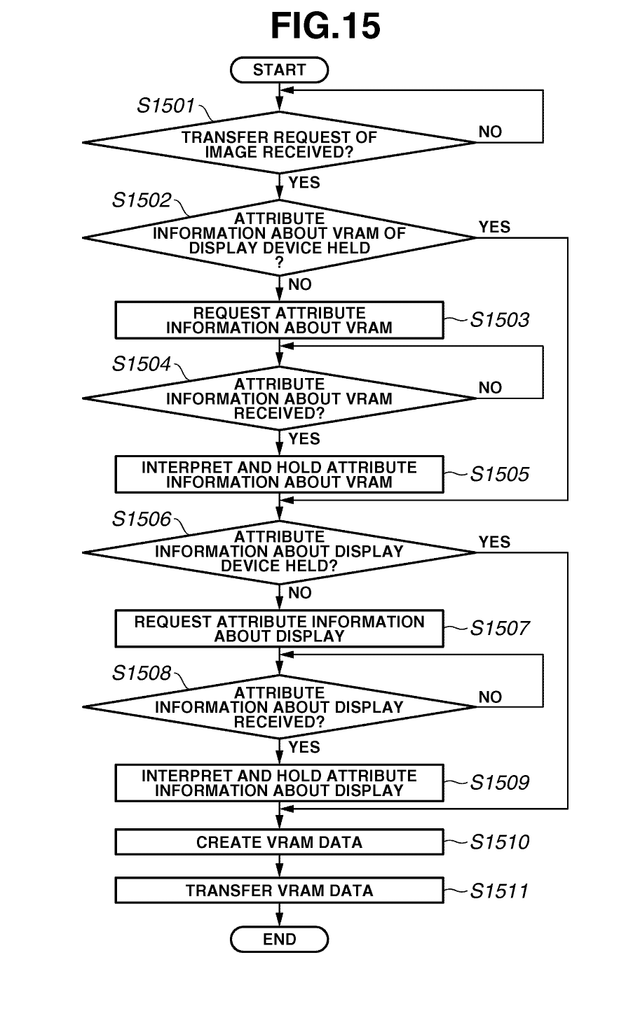

A system in FIG. 13 includes the display data transmission device 101 and the display device 102. First, in a sequence SQ1303, the display device 102 requests an image transfer from the display data transmission device 101 designating an image. The display data transmission device 101 that received the request of the transfer, returns Ack (acknowledge) of the image transfer request (sequence SQ1304). Further, when the display data transmission device 101 and the display device 102 start a session for the first time, the display device 102 issues a request to transfer attribute information (sequences SQ1305 and SQ1308). More specifically, the attribute information is the information about the attribute of display such as resolution or the attribute of the VRAM 303b that defines which image data are placed in the VRAM 303b of the display device 102. The display device 102 transfers this attribute information to the display data transmission device 101 (sequences SQ1306 and SQ1309) and transmits Ack (sequences SQ1307 and SQ1310) at the same time. The display data transmission device 101 transmits the display data (sequence SQ1311), and the display device 102 returns Ack (sequence SQ1312). The processing of sequences SQ1305 to SQ1312 will be later described in detail in FIGS. 14 and 15.

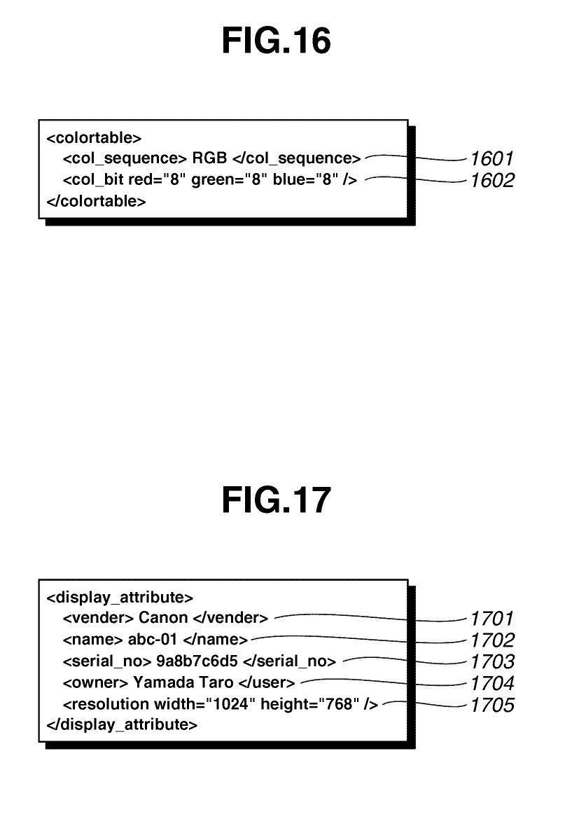

The flowchart of operation executed by the CPU 301 of the display device 102 is shown in FIG. 14. The flowchart of operation executed by the CPU 201 of the display data transmission device 101 is shown in FIG. 15. Further, FIG. 16 is an exemplary description of the attribute information about the VRAM. FIG. 17 is an exemplary description of the attribute information on display.

In step S1401, the CPU 301 requests the display data transmission device 101 to transfer an image from the display device 102. The display data transmission device 101 receives the request of the image transfer in step S1501. In step S1502, the CPU 201 confirms whether the attribute information about the VRAM of the display device 102 is being held. If the CPU 201 does not hold the attribute information about the VRAM, in step S1503, the CPU 201 requests to transfer the attribute information about the VRAM. In step S1402, the display device 102 receives the request of the attribute information about the VRAM. Then, the CPU 301 generates the attribute information about the VRAM from the attribute data of the VRAM stored in the storage and transmits the attribute of the VRAM to the display data transmission device 101 in step S1403.

As shown in FIG. 16, attribute information is the XML format data and represents color data that are lined up in an order of red, green and blue by “RGB” as described on a line 1601. An expression given by (Red=“8” green=“8” blue=“8”) which is described on a line 1602, shows that the whole colors of red, green and blue are 8 bits. As shown by this description, the Bit Map data written into the VRAM 303b in the present exemplary embodiment are arranged in an order of red (R), green (G) and blue (B) for every one pixel of the image shown in FIG. 7. Each of red, green and blue is constituted of 8 bits. The CPU 301 of the display device 102 generates, based on this VRAM 303b, the description data of the attribute (attribute information about VRAM) which are transmitted to the display data transmission device 101. In step S1504, the display data transmission device 101 receives the attribute information about the VRAM of the display device 102. In step S1505, the CPU 201 interprets the contents of the attribute information about the VRAM and holds the contents in the storage.

Similarly, in step S1506, the CPU 201 of the display data transmission device 101 determines whether the attribute of the display device 102 is being held. If the CPU 201 does not hold the attribute, in step S1507, the CPU 201 requests the attribute information about the display device 102. In step S1404, when the display device 102 receives the request for the attribute of display, in step S1405, the CPU 301 of the display device 102 generates data that describe the attribute information about display shown in FIG. 17. The CPU 301 of the display device 102 transmits the generated data to the display data transmission device 101. The attribute information about display shown in FIG. 17 includes a name of a maker shown on a line 1701, a mold number of the display device shown on a line 1702, a serial number of the display device shown on a line 1703, an owner of the display device shown on a line 1704 and size of a display area shown on a line 1705.

In step S1508, the display data transmission device 101 receives the attribute information about display in FIG. 17. In step S1509, the CPU 201 interprets the contents of the attribute information about display and stores them in the storage.

Next, in step S1510, if necessary, the display data transmission device 101 decodes the target image. In the step S1508, the display data transmission device 101 resizes the image into a suitable size based on resolution information included in the received attribute information about display. In the step S1504, the display data transmission device 101 generates VRAM data of the display device 102 based on the received attribute of the VRAM and transmits them to the display device 102 in step S1511. Note that the VRAM data designates the display data corresponding to the received attribute of the VRAM.

When the display device 102 receives the VRAM data in step S1406, the display device 102 simply transfers the VRAM data to the VRAM 303b in step S1407 and displays them on the display device 307 in step S1408.

As described above, according to the above-described exemplary embodiments, the display data transmission device switches the format of the display data corresponding to the security level of the display device. For example, to a low-reliability user, data of low re-usablity are transmitted where possible. Accordingly, information can be displayed while danger that the data is leaked outside, can be reduced to a minimum. Thus, the data transmission device or display system can be provided that is conveniently operable and secured.

Further, as the security level of the display device, the level intrinsically allocated to the display device, the level allocated to a user who utilizes the display device or the level allocated to an area using the display device can be utilized. Thus, the confidentiality of information can be flexibly maintained.

Furthermore, the display data that is to be transmitted, is created beforehand. Therefore, when the display data transmission device receives the transmission request from the display device, the display data that is already stored can be read and transmitted. Thus, the processing load of the display data transmission device can be reduced and the transmission having a good response can be made.

According to the above-described exemplary embodiment, the display data having high convenience can be provided while security is maintained.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2005-233593 filed Aug. 11, 2005, which is hereby incorporated by reference herein in its entirety.

1. A display data transmission device, comprising:
an acquisition unit configured to acquire address information of a display device connected through a network;
a determining unit configured to determine a security level of the display device based on address information acquired by the acquisition unit such that a first security level is determined for a first display device connected to a first network, a second security level higher than the first security level is determined for a second display device connected to a second network, and a third security level higher than the second security level is determined for a third display device connected to a third network;
a creating unit configured to create first display data by converting original data based on a first format corresponding to the first security level and to create second display data by converting the original data based on a second format corresponding to the second security level higher than the first security level, a display quality of the first display data being changed in accordance with a size change of a display size and the display quality of the second display data not being changed in accordance with the size change of the display size; and
a transmission unit configured to transmit the first display data to the first display device for which the first security level is determined by the determining unit, to transmit the second display data to the second display device for which the second security level higher than the first security level is determined by the determining unit, and to transmit the original data to the third display device for which the third security level higher than the second security level is determined by the determining unit,
wherein the original data can be edited by using an application used for creating the original data, and the first and second display data cannot be edited by using the application used for creating the original data.

2-3. (canceled)

4. A method for transmitting display data by a display data transmission device, comprising:
acquiring address information of a display device connected through a network;
determining a security level of the display device based on the acquired address information such that a first security level is determined for a first display device connected to a first network, a second security level higher than the first security level is determined for a second display device connected to a second network, and a third security level higher than the second security level is determined for a third display device connected to a third network;
creating first display data by converting original data based on a first format corresponding to the first security level and creating second display data by converting the original data based on a second format corresponding to the second security level higher than the first security level, a display quality of the first display data being changed in accordance with a size change of a display size and the display quality of the second display data being not changed in accordance with the size change of the display size; and
transmitting the first display data to the first display device for which the first security level was determined, transmitting the second display data to the second display device for which the second security level higher than the first security level was determined, and transmitting the original data to the third display device for which the third security level higher than the second security level was determined,
wherein the original data can be edited by using an application used for creating the original data, and the first and second display data cannot be edited by using the application used for creating the original data.

5. (canceled)

6. A computer-readable recording medium having stored thereon, a computer program that causes a display data transmission device to perform a method for transmitting display data according to claim 4.

7-9. (canceled)

10. The display data transmission device according to claim 1, wherein the creating unit creates the first and second display data before acquisition of the address information by the acquisition unit.

11. The method according to claim 4, wherein creating first display data includes creating the first and second display data before the address information is acquired.
